(19) United States
(12) Patent Application Publication
(10) Pub. No.: US 2026/0116584 A1
(43) Pub. Date: Apr. 30, 2026

(54) ELECTRIC THRUSTERS INCLUDING BUBBLE FORMATION

(71) Applicant: Massachusetts Institute of Technology, Cambridge, MA (US)

(72) Inventor: Paulo C. Lozano, Arlington, MA (US)

(73) Assignee: Massachusetts Institute of Technology, Cambridge, MA (US)

(21) Appl. No.: 19/367,766

(22) Filed: Oct. 23, 2025

Related U.S. Application Data
(60) Provisional application No. 63/711,687, filed on Oct. 24, 2024.

(51) Int. Cl. B64G 1/40

(52) U.S. Cl. CPC B64G 1/401

(57) ABSTRACT

In some embodiments, electric thrusters and/or related methods may form bubbles with a liquid shell and a gas core. The bubbles may be electrically charged, and an accelerating potential is applied to the electrically charged bubbles to generate thrust.

### RELATED APPLICATIONS

This application claims the benefit of priority under 35 U.S.C. § 119(e) of U.S. Provisional Application Ser. No. 63/711,687, filed Oct. 24, 2024, the disclosure of which is incorporated herein by reference in its entirety.

### FIELD

Disclosed embodiments are related to electric thrusters including bubble formation.

### BACKGROUND

Electric propulsion (EP) for spacecraft based on the electrostatic acceleration of relatively heavy charged particles at high efficiency has been considered as an ideal option to improve overall performance, in particular by increasing thrust-to-power. This is because the maximum thrust delivered by electrostatic accelerators depends on the electric field E through the normal component of the Maxwell stress tensor ½ ε₀E². The larger the applied voltage, the larger the field. For a given specific impulse, larger voltages are possible when using heavier particles. However, while low density EP systems, like Hall and ion engines exhibit good performance (generally >50% efficiency) for Iₛₚ>1000 s, this performance drops significantly at lower values of Iₛₚ. For example, high density EP systems, such as resistojets and arcjets, have much lower conversion efficiencies (sometimes as low as 20%) and in general Iₛₚ<600 s (unless light species, like hydrogen, are used).

### SUMMARY

In some embodiments, an electric thruster may comprise at least one coaxial sprayer, wherein each coaxial sprayer of the at least one coaxial sprayer includes a core channel and an exterior channel at least partially surrounding the core channel, a liquid source configured to contain a liquid and in fluid communication with the exterior channel of each coaxial sprayer of the at least one coaxial sprayer, a gas source configured to contain a gas and in fluid communication with the core channel of each coaxial sprayer of the at least one coaxial sprayer, an upstream electrode configured to apply a voltage potential to the liquid flowing from the liquid source to the at least one coaxial sprayer, and an extractor electrode configured to accelerate bubbles comprising the gas and the liquid emitted from the at least one coaxial sprayer.

In some embodiments, an electric thruster may comprise at least one sprayer, wherein each sprayer is configured to form bubbles including a shell comprising a liquid and a core comprising a gas, a liquid source configured to contain the liquid and in fluid communication with the at least one sprayer, a gas source configured to contain the gas and in fluid communication with the at least one sprayer, an upstream electrode configured to apply a voltage potential to the liquid flowing from the liquid source to the at least one sprayer, and an extractor electrode configured to accelerate the bubbles emitted from the at least one sprayer.

In some embodiments, an electric thruster may include at least one coaxial electrosprayer. Each coaxial electrosprayer of the at least one coaxial electrosprayer may include a core channel and an exterior channel at least partially surrounding the core channel. The electric thruster may include a liquid source configured to contain a liquid and in fluid communication with the exterior channel of each coaxial electrosprayer of the at least one coaxial electrosprayer. The electric thruster may include a gas source to contain a gas and in fluid communication with the core channel of each coaxial electrosprayer of the at least one coaxial electrosprayer. The electric thruster may include an upstream electrode configured to apply a voltage potential to a liquid flowing from the liquid source to the at least one coaxial electrosprayer. The electric thruster may include an extractor electrode configured to accelerate bubbles comprising the gas and liquid emitted from the at least one coaxial electrosprayer.

In some embodiments, a method for generating thrust may include forming bubbles, wherein each bubble includes a shell comprising a liquid and a core comprising a gas; electrically charging the bubbles; and applying an accelerating potential to the electrically charged bubbles to generate thrust.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of a coaxial electrosprayer where gas and shell liquid flow rates may be regulated separately according to some embodiments;

FIG. 2 is a schematic of a bubble emitted by a coaxial electrosprayer with a gas core of radius R₁ surrounded by a shell of outer radius R₂ with a shell thickness t=R₂−R₁ according to some embodiments;

FIG. 3 is a schematic of an electric thruster according to some embodiments;

FIG. 4A depicts a schematic of an electric thruster comprising at least one coaxial capacitive sprayer according to some embodiments;

FIG. 4B is a schematic of an electric thruster comprising an externally fed capacitive sprayer comprising an exterior surface at least partially surrounding a gas channel according to some embodiments;

FIG. 4C is a schematic of an electric thruster comprising an externally fed capacitive sprayer comprising a planar exterior surface in communication with at least one gas channel according to some embodiments;

FIG. 5 is a graph of thrust-to-power as a function of Iₛₚ at different efficiencies for several types of electric propulsion technologies according to some embodiments;

FIG. 6A is a graph of the dependence of η/K as a function of β for different bubble sizes (diameter) with Hydrogen as a core gas according to some embodiments;

FIG. 6B is a graph of the dependence of η/K as a function of β for different bubble sizes (diameter) with Helium as a core gas according to some embodiments;

FIG. 6C is a graph of the dependence of η/K as a function of β for different bubble sizes (diameter) with Methane as a core gas according to some embodiments;

FIG. 6D is a graph of the dependence of η/K as a function of β for different bubble sizes (diameter) with Nitrogen as a core gas according to some embodiments;

FIG. 7A is a graph of the augmentation factor α as a function of β for different core gases and bubble sizes according to some embodiments;

FIG. 7B is a graph of the augmentation factor α as a function of β for different core gases and bubble sizes according to some embodiments;

FIG. 7C is a graph of the augmentation factor α as a function of β for different core gases and bubble sizes according to some embodiments;

FIG. 8A is a graph of specific impulse as a function of β for different core gases and bubble sizes at an acceleration voltage of 10 kV according to some embodiments;

FIG. 8B is a graph of specific impulse as a function of β for different core gases and bubble sizes at an acceleration voltage of 10 kV according to some embodiments;

FIG. 8C is a graph of specific impulse as a function of β for different core gases and bubble sizes at an acceleration voltage of 10 kV according to some embodiments;

FIG. 9 is a graph of thrust for different bubble sizes at an acceleration voltage of 10 kV as a function of the non-dimensional flow parameter η according to some embodiments;

FIG. 10A is a graph of thrust at an acceleration voltage of 10 kV as a function of the non-dimensional flow parameter η for nitrogen core gas at different values of electric conductivity K according to some embodiments;

FIG. 10B is a graph of thrust at an acceleration voltage of 10 kV as a function of the non-dimensional flow parameter η for nitrogen core gas at different values of electric conductivity K according to some embodiments;

FIG. 10C is a graph of thrust at an acceleration voltage of 10 kV as a function of the non-dimensional flow parameter η for nitrogen core gas at different values of electric conductivity K according to some embodiments;

FIG. 10D is a graph of thrust at an acceleration voltage of 10 kV as a function of the non-dimensional flow parameter η for nitrogen core gas at different values of electric conductivity K according to some embodiments;

FIG. 11A is a graph of thrust at an acceleration voltage of 10 kV as a function of the non-dimensional flow parameter η for K=0.1 S/m and Hydrogen as a core gas according to some embodiments;

FIG. 11B is a graph of thrust at an acceleration voltage of 10 kV as a function of the non-dimensional flow parameter η for K=0.1 S/m and Hydrogen as a core gas according to some embodiments;

FIG. 11C is a graph of thrust at an acceleration voltage of 10 kV as a function of the non-dimensional flow parameter η for K=0.1 S/m and Hydrogen as a core gas according to some embodiments;

FIG. 11D is a graph of thrust at an acceleration voltage of 10 kV as a function of the non-dimensional flow parameter η for K=0.1 S/m and Hydrogen as a core gas according to some embodiments;

FIG. 12 is a graph of core gas mass to total mass ratio for different gases and a bubble size of 0.5 m according to some embodiments; and

FIG. 13 is a graph of capacitive charging (at Ve=1000 V) of a bubble contrasted with ½ of the Rayleigh limit.

### DETAILED DESCRIPTION

Current electric propulsion systems for spacecraft do not optimize for high thrust to power efficiencies within the specific impulse (Iₛₚ) range of 500-1000 s. Although certain electric propulsion systems such as Hall and ion thrusters operate with high efficiencies for Iₛₚ greater than 1000 s, this efficiency drops at lower Iₛₚ. Other electric propulsion systems such as resistojets and arcjets have much lower efficiencies and operate with Iₛₚ less than 600 s, which may lead to long deployment times and more use of propellant. Thus, the inventors have recognized that existing electric propulsion systems are unable to combine higher specific impulse with relatively larger efficiencies (i.e., reduced propellant usage). While the flexibility of delivering an Iₛₚ as high as possible may be a positive attribute, many missions in space such as rapid repositioning of small satellites optimize within the Iₛₚ range of 500-1000 s, making it particularly beneficial to operate an electric propulsion system with higher efficiencies within this range.

The Inventors have appreciated that one method of performing electric propulsion is through using charged particles that are heavier than ions. Relatively heavier particles allow the use of larger voltages, thereby increasing thrust delivered by electrostatic accelerators. However, using particles that are too heavy may result in the use of excessively large acceleration voltages, which may lead to difficulty during implementation. Additionally, an issue with the use of heavy particles is the ability to charge the particles such that the charge-to-mass ratio (specific charge) results in operating at a high Iₛₚ at moderate voltages. In the past, “dusty” plasmas have been considered for this purpose. Unfortunately, gas-phase approaches to particle charging are not very effective, since the Coulomb barrier that builds up when charges start collecting on the particle make it increasingly difficult for additional charges to arrive at their surface. Other methods, like photoemission are also quite limited to reach a highly charged state.

In view of the above, the Inventors have recognized the benefits associated with an electric thruster configured to form and accelerate charged liquid bubbles to generate thrust. A benefit of creating charged bubbles is that the bubbles have a significantly lower average mass when compared to droplets of the same size, thus increasing specific charge. Additionally, the relatively large size of the charged bubbles mitigates against decreases in efficiency which may be caused by ion emission as seen in cases with relatively smaller particles. The Inventors have appreciated that any desired method and/or configuration can be used to form charged bubbles as the disclosure is not so limited. For example, in some embodiments, the charged bubbles can be formed using a coaxial electrosprayer. In some embodiments, the charged bubbles can be formed through capacitive coupling in which the bubbles are formed using a surface in electrical contact with an electrode and are accelerated towards a counter-electrode until the bubble detaches from the surface. As a result, charged bubbles can be formed and accelerated to produce thrust.

As mentioned above, the Inventors have appreciated that electrospraying is a technique that may be used to produce highly charged liquid droplets by applying a strong electric field to a stream of conductive liquid. One method of electrospraying involves using a capillary emitter that carries a stream of conductive liquid toward an outlet exit. After passing through the outlet, a strong electric field is applied during the formation of a slender charged jet that eventually breaks up into charged particles. While the charging efficiency of droplets during electrospray may be high, the specific charge of the particles may be relatively low for larger droplets. By electrospraying a conductive liquid at low flow rates, it is possible to obtain extremely small, charged droplets with increased specific charges. However, these smaller droplets may undergo direct ion evaporation when exposed to the large electric fields under vacuum which may lead to decreased efficiencies for smaller droplet sizes.

In view of the above, the inventors have recognized the benefits associated with using one or more electrosprayers or other appropriate type of bubble generator to form charged bubbles including a liquid shell and gas core that are then accelerated using an applied accelerating potential to produce thrust. Further, as elaborated on further below, the bubbles may be formed using one or more gases to form the core of the bubbles that are substantially immiscible with an electrically conductive liquid used to form the shell of the bubbles. A voltage and resulting electrical charge may also be relatively easily applied to the liquid shell of the bubbles due to the one or more electrosprayers, or other appropriate component of a bubble generator, applying a voltage potential to the liquid used to form the liquid shells of the bubbles.

In some embodiments, an electric thruster used to implement the above method may include at least one coaxial electrosprayer. Each of the one or more coaxial electrosprayers may include a core channel and an exterior channel that extends at least partially along and at least partially surrounding the core channel. For example, the exterior channel of a coaxial electrosprayer may extend completely around an outer perimeter of the core channel adjacent to the outlets of each channel at a distal end of the coaxial electrosprayer. A liquid source configured to contain an electrically conductive liquid may be configured to be in fluid communication with the exterior channel of each coaxial electrosprayer in one or more operating modes. Correspondingly, a gas source may be configured to be in fluid communication with the interior core channel of each coaxial electrosprayer in one or more operating modes. However, instances in which the gas source and/or liquid source are fluidly decoupled from the at least one coaxial electrosprayer in one or more operating modes are also contemplated. An upstream electrode of the electric thruster may be used to apply a voltage potential to liquid flowing from the liquid source to the at least one coaxial electrosprayer. As gas and liquid flow from the corresponding gas source and liquid source to the at least one coaxial electrosprayer, bubbles comprising a gas core and liquid shell are emitted from the at least one coaxial electrosprayer with a desired charge. An extractor electrode may be configured to apply an appropriate accelerating potential to the charged bubbles to accelerate the bubbles and generate a desired thrust.

In the above embodiment, at least one coaxial electrosprayer is described. However, it should be understood that in other embodiments a plurality of coaxial electrosprayers with a corresponding arrangement of one or more upstream and downstream electrodes may be used to generate and accelerate a plurality of separate streams of charged bubbles to generate thrust. Thus, the disclosed systems and methods may be easily scaled to generate larger amounts of thrust.

In addition to the above, the Inventors have also recognized that capacitive charging is another technique that can be used to form electrically charged bubbles. Accordingly, in some embodiments, an electric thruster may comprise an electric sprayer an upstream electrode in electrical contact with a surface including one or more openings formed therein for passage of a gas. In some embodiments, the electric thruster may comprise a gas source and a liquid source similar to those described above which cooperate to form electrically charged bubbles. The upstream electrode may be configured to apply a voltage potential to a liquid in communication with the surface. As a result, a bubble can be formed having a gas core from the gas emitted from the one or more openings and a charged liquid shell from the liquid. The resulting bubble may have an electrical charge polarized on the surface of the liquid. In some embodiments, the electric thruster may comprise one or more extractor electrodes configured to accelerate bubbles comprising the gas and the liquid emitted from the at least one coaxial electrosprayer. For example, in some embodiments, the electrically charged bubble can move towards a first counter-electrode biased to a first voltage until the bubble detaches from the surface. When the bubble detaches, the bubble can acquire a capacitive charge. In some embodiments, further acceleration can be provided by adding a second counter-electrode which is biased to a second voltage with respect to the first voltage of the first counter electrode. Accordingly, the charged bubbles can be accelerated as described above to generate thrust.

In some embodiments, an electric sprayer may comprise at least one coaxial sprayer comprising a coaxial tube having a core channel and an exterior channel that at least partially surrounds a core channel. In this regard, the electrically conductive liquid may flow through the exterior channel while gas flows through the interior channel in order to form electrically charged bubbles. Such a coaxial sprayer may have similar configuration to the coaxial electrosprayer described above; however the bubbles may instead be generated using a capacitive charging method rather than electrospraying.

In some embodiments, an electric thruster may comprise at least one sprayer comprising an exterior surface and a gas channel in communication with the exterior surface. For example, the at least one sprayer may comprise an exterior surface comprising at least one opening. A conductive liquid can be disposed on the exterior surface of the at least one sprayer and gas can flow through the at least one opening in the exterior surface to form electrically charged bubbles. For example, the conductive liquid may wet an exterior surface of the at least one sprayer. As described in more detail below, in some embodiments, the liquid may passively wet the exterior surface of the at least one sprayer. It is contemplated that in some embodiments, the exterior surface may at least partially surround the gas channel. In some embodiments, the exterior surface may comprise a planar surface wherein the gas channel extends through the planar surface and is in fluid communication with the liquid disposed on the exterior surface.

Wetting the exterior surface of the at least one sprayer with the conductive liquid can be achieved passively in some embodiments. For example, in some embodiments, one or more surfaces of the emitter can be engineered (e.g., through surface conditioning, texturing, structuring, etc.) such that the conductive liquid has an affinity for and wets the emitter surface. This can be beneficial to ensure that the conductive liquid's affinity for the emitter surface is greater than the conductive liquid's affinity for other components of the thruster (e.g., a conductive liquid supply line). Thus, capillary forces and/or wetting of the surface may be used to feed the conductive liquid to the at least one sprayer from an associate conductive liquid source. While passive wetting is contemplated above, the Inventors have appreciated that in some embodiments, a pressure head can be applied to the conductive liquid to ensure the conductive liquid flows to the exterior surface.

The Inventors have appreciated that in some embodiments, the conductive liquid may be directly exposed to vacuum. However, since in some embodiments the conductive liquid has zero vapor pressure, the conductive liquid may not be lost through evaporation. The Inventors have recognized that the capacitive charging techniques described above can be used in addition to or alternatively to electrospraying to form charged bubbles. Further, the Inventors have appreciated that capacitive charging may be beneficial for simplifying manufacturing and/or implementation due at least in part to an ability to passively wet a surface with a conductive liquid according to some embodiments. Of course, it should be understood that any appropriate type of sprayer capable of generating a bubble that may be electrically charged may be used with any of the embodiments disclosed here as the disclosure is not so limited. As used herein, the disclosed sprayers used to generate the bubbles may also be referred to as a bubble generators.

In the above embodiments, the production of specific impulses in the range of 500-1000s s with the disclosed ranges is described. However, it should be understood that the current disclosure is not limited to systems exhibiting this range of specific impulses as the disclosure is not so limited.

It should be understood that any appropriate electrically conductive liquid may be used with the disclosed methods and systems. Without wishing to be bound by theory, the liquid may be electrically conductive to permit a charge to be applied to the liquid shells of the bubbles. Appropriate electrical conductivities may be between or equal to 0.0001 S/m and 10 S/m. Additionally, in some embodiments, the electrically conductive liquid may also be a low, or in some instances substantially zero, vapor pressure liquid. Without wishing to be bound by theory, this may advantageously mitigate, and in some instances, completely, prevent bursting of the bubbles due to evaporation of the liquid shell in a vacuum. In some embodiments, a vapor pressure of the electrically conductive liquid at a temperature of 20° C. may be equal to or between 10⁻¹⁵ and 0.1 mmHg. In some embodiments, the liquid may be an ionic liquid. In other embodiments, the liquid may comprise a vacuum oil such as a dielectric oil, oil including dispersed conductive microparticles, or other appropriate liquids. In some embodiments, the liquid may comprise conventional solvents used in electrospraying, for example glycerol, formamide, and other appropriate liquids. In some embodiments, the liquid may comprise CF₃CH₂MeIm-Tf₂N. Combinations of the above and/or other appropriate electrically conductive liquids may also be used. Thus, it should be noted that there are a wide variety of liquids that may have suitable properties, and the present disclosure may be used with any appropriate liquid capable of being used to form bubbles with an encapsulated gas core with the disclosed methods and systems.

It should be understood that the disclosed methods and systems may be used with a number of different pure and/or mixed gases. In some embodiments, the gas may be substantially immiscible with the liquid used to form the charged bubbles. Without wishing to be bound by theory, using a gas that is substantially immiscible with the liquid may facilitate the formation of a bubble with uniform shell thickness due to a lack of mixing between the core gas and the liquid shell. In either case, appropriate gases may include, but are not limited to, nitrogen, oxygen, helium, methane, H₃, combinations of the above, and/or any other appropriate gas. To provide a desired density, in some embodiments, a gas, which again may be a pure or mixed gas, may have an average mass equal to or between 2 to 40 AMU to provide a desired performance of the electric thrusters. In some embodiments, the gas may have an average mass equal to or between 2 to 200 AMU. Of course, gasses with average atomic masses different from the forgoing are also contemplated.

In some embodiments, bubbles created by a coaxial emitter may have an average maximum transverse dimension (e.g. outer diameter) that is greater than or equal to 10 nm, 100 nm, 250 nm, 500 nm, 1 μm, 10 μm, 25 μm, 50 μm, 100 μm, 150 μm, or other appropriate range. The average maximum transverse dimension of the bubbles may also be less than or equal to 150 μm, 100 μm, 50 μm, 25 μm, 10 μm, 1 μm, 500 nm, or other appropriate ranges. Combinations of the above are contemplated. For example, in some embodiments, the bubbles may have an average maximum transverse dimension between or equal to 250 nm and 1 μm. In other embodiments, the bubbles may have an average maximum transverse dimension between or equal to 10 nm and 50 microns. In some embodiments, the bubbles may exhibit a ratio of an average shell thickness and the average maximum transverse dimension that is between or equal to 0.5 and 10⁻⁴. Without wishing to be bound by theory, controlling the size of the bubble and thickness of the liquid shell may be advantageous for controlling the thrust to power ratio, which in some embodiments, may provide relatively large efficiencies (e.g., approximately 50% to 70%) within the Iₛₚ range of 500-1000 s, though again other performance regimes may also be designed for.

Depending on the specific liquids, gases, and applications, different specific charges of the resulting bubbles may be applied. An appropriate average specific charge of the bubbles may be greater than or equal to 5 C/kg, 10 C/kg, 15 C/kg, 500 C/kg, 1,000 C/kg, 1,500 C/kg, 2,000 C/kg, and/or other appropriate ranges. Correspondingly, the average specific charge of the bubbles may be less than or equal to 10,000 C/kg, 5,000 C/kg, 2,000 C/kg, 1,000 C/kg, 100 C/kg, 20 C/kg, 15 C/kg, 10 C/kg, or other appropriate range. Combinations of the forgoing are contemplated, including, for example, an average specific charge that is between or equal to 5 C/kg and 20 C/kg. In another embodiment, an average specific charge may be between or equal to 5 C/kg and 10,000 C/kg.

Any appropriate accelerating potential may be applied to the charged bubbles to generate a desired thrust. For example, appropriate accelerating potentials that may be applied by an extractor electrode to the charged bubbles may be greater than or equal to 1 kV, 2 kV, 5 kV, 10 kV, 25 kV, or other appropriate potential. The accelerating potential may also be less than or equal to 50 kV, 25 kV, 10 kV, 5 kV, 2 kV, or other appropriate potential. Combinations of the forgoing ranges are contemplated including, for example, an accelerating potential between or equal to 1 kV and 10 kV. In another embodiment, an accelerating potential may be between or equal to 1 kV to 50 kV.

The disclosed systems and methods may offer various benefits. For example, the significantly lower mass of the bubbles when compared with a droplet of the same size may boost the specific charge of the generated bubbles. This modification would allow the specific impulse to increase without decreasing the particle size, thus helping to maintain operation of the disclosed methods and systems in the pure droplet regime in some embodiments. The disclosed methods and system may thus exhibit higher efficiencies with larger specific impulses. This may help improve thrust-to-power, especially in missions that optimize in the noted ranges of Iₛₚ, such as the rapid repositioning of small satellites in constellations, orbital raise and de-orbit, among many others.

The disclosed electric thrusters and methods may be used for any appropriate application including spacecraft thrusters (e.g., satellites, and other spacecraft). The disclosed electric thrusters and methods may be of particular use in deployment of satellite constellations where efficient rapid deployment may be desirable. Of course, the disclosed methods and systems may be used for any other appropriate application for electric thrusters as well as the disclosure is not so limited.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

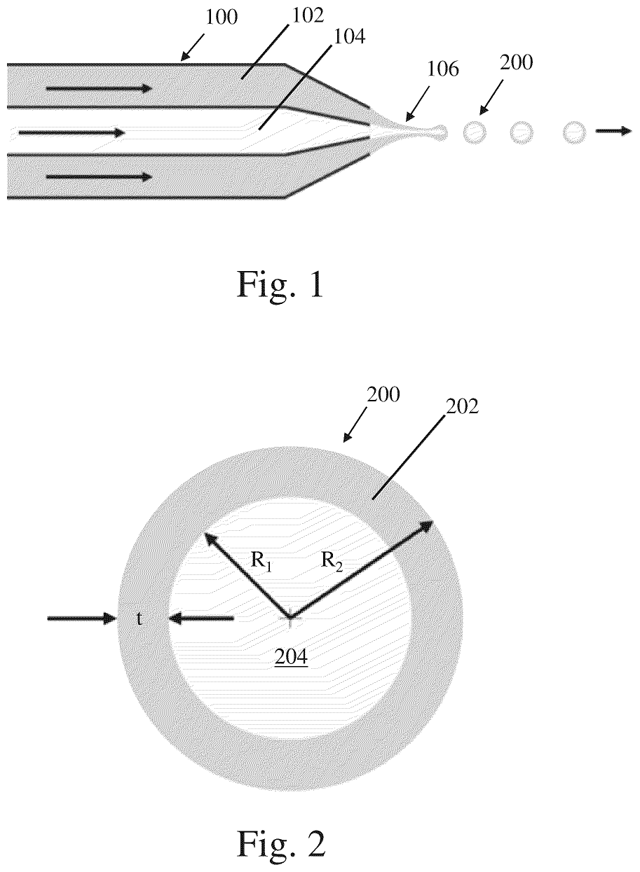

FIG. 1 illustrates one embodiment of the formation of bubbles using a coaxial electrosprayer where the gas and shell liquid flow rates may be regulated separately. FIG. 2 shows a schematic of a charged bubble emitted by the coaxial electrospray of FIG. 1. As shown in the figures, according to some embodiments, a coaxial electrosprayer 100 may include a core channel 104 configured to flow a gas from a corresponding gas source to an associated distal outlet from the core channel 104. The coaxial electrosprayer may include an exterior channel 102 that at least partially surrounds the core channel and is configured to flow liquid from a liquid source to a distal outlet from the exterior channel 102. A charge may be applied to the liquid prior to flowing out of the coaxial electrosprayer. In some embodiments, the core channel 104 may be configured to flow a substantially immiscible gas and the exterior channel 102 may be configured to flow an electrically conductive liquid to the associated distal outlets.

As the immiscible gas and conductive liquid exit electrosprayer 100 through the outlets of the core channel 104 and exterior channel 102, an electric field may be applied to deform the gas and liquid into a cone-jet 106. As the flow destabilizes, the stream may break apart to form a stream of a plurality of separate charged bubbles 200 comprising gas core 204 and liquid shell 202 that are emitted away from the coaxial electrosprayer. Due to the use of a substantially immiscible gas, gas core 204 may not substantially mix with liquid shell 202. Additionally, the charged bubbles 200 may have a substantially lower average mass when compared to particles of a similar size due to the use of core gas 204, allowing the bubbles 200 to have a higher specific charge as compared to solid particles of the same size. Gas core 204 may have a radius R₁ and liquid shell 202 may have an outer radius R₂. Charged bubble 200 may have a shell thickness of t=R₂−R₁.

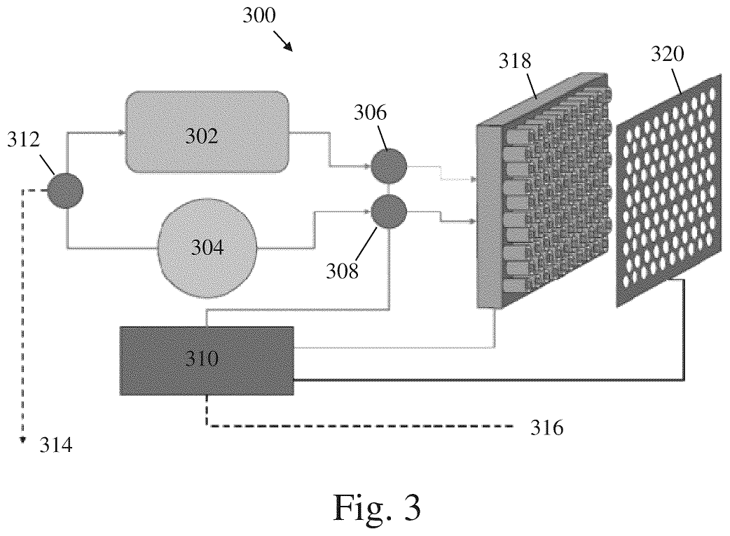

FIG. 3 shows a possible configuration of an electric propulsion system according to one embodiment. In some embodiments, an electric thruster 300 may comprise a liquid source 302 in fluid communication with an exterior channel 102 of at least one coaxial electrosprayer 100. Additionally, a gas source 304 may be in fluid communication with a core channel 104 of at least one coaxial electrosprayer 100. In some embodiments liquid source 302 may be pressurized using a pressurizing gas to force fluid to flow from liquid source 302 to exterior channel 102 of the coaxial emitter. In some embodiments, the pressurizing gas may be supplied by the gas source 304, however in other embodiments the pressurizing gas may be a separate gas source. In some embodiments, a valve 312 may be configured to regulate the pressure supplied by the pressurizing gas to the liquid source. In other embodiments, liquid source 302 may be pressurized using pumps or any other types of pressure sources.

In some embodiments, a thruster may comprise a single coaxial emitter 318. In other embodiments, and as depicted in the figure, an electric thruster 300 may comprise a plurality of coaxial emitters 318 arranged in an array as elaborated on further below. Depending on the specific application, a single emitter may be advantageous due to size constraints or relatively lower thrust requirements of a specific mission. An array of emitters may be advantageous where relatively larger amounts of thrust are desired, for example during rapid deployment of space assets.

Various control valves and regulators may control the flow rates and pressures throughout the electric propulsion system. In some embodiments, flow rates of the electrically conductive liquid and the gas may be regulated separately using appropriate flow controls. A liquid control valve 306 may regulate the flow from liquid source 302 to the exterior channel(s) 102 of the one or more associated coaxial electrosprayers 318. A gas control valve 308 may regulate the flow from gas source 304 gas to core channel 104. Regulating the flow of conductive liquid separately from the flow of gas may allow for control over the size of the charged bubbles and the thickness t of the liquid shell. Flow rates of the immiscible gas and the conductive liquid may be regulated to control relative mass flow rates, volumetric flow rates, or other appropriate parameters.

In some embodiments, a power processing unit (PPU) 310, or other appropriate type of one or more controllers including one or more processors and associated non-transitory computer readable memory, may be configured to provide electrical signals, control signals, and/or power to the various components of the illustrated electric thruster 300. As shown in FIG. 3, PPU 310 may bias an upstream electrode, not depicted, which may be associated with the flow of liquid into the one or more coaxial electrosprayers 318 to apply a voltage potential to conductive liquid flowing from liquid source 302 to at least one of the coaxial electrosprayers 318 such that the thruster head is biased to a different voltage with respect to extractor electrode 320. In some embodiments, an electrical potential may be applied directly to the conductive liquid. In some embodiments, an electrical potential may be applied directly to a thruster array 318 of coaxial emitters to bias the thruster array to an operational voltage with respect to a downstream extractor electrode 320. In some embodiments PPU 310 may apply a voltage potential to an extractor electrode 320 to bias the extractor electrode 320 with respect to thruster array 318. This voltage potential may accelerate charged bubbles comprising gas core 204 and liquid shell 202 emitted from at least one of the coaxial electrosprayers in the downstream direction to create thrust.

As with other electric thruster technologies, there are different ways to implement a propulsion system based on the disclosed concepts. Referring again to FIG. 3, a system may include two reservoirs, one for the liquid (e.g., an ionic liquid) and the other for the core gas. The gas tank can be also used to provide the static pressure of the liquid propellant tank to force liquid flow into the thruster head. In the particular example shown in the figure, there are a number of valves and regulators to control the flow rates and pressures throughout the system, including a regulated line that brings the gas into the thruster head. A power processing unit (PPU) provides the electrical signals and controls to the system. As shown, it biases the thruster head to the operational voltage with respect to the extractor plate. There are three different configurations that could be used to complete the electric circuit:

In some embodiments, the thruster may be biased to a positive voltage with respect to the extractor electrode to produce positively charged bubbles. To prevent spacecraft charging to a negative potential, the PPU may power a cathode 316 such that the cathode produces a stream of electrons with substantially the same current as the electrospray to provide charge neutralization of the system.

In some embodiments, a bipolar system may be implemented. Such an arrangement may comprise a mirrored system that includes an additional liquid tank 314 and another thruster head. In this way, one thruster head may be biased positive to produce positively charged bubbles, while the mirrored thruster may be biased negative to create a negatively charged stream of bubbles. If balanced, such configuration may be able to achieve spacecraft and beam neutrality without a cathode. In case the currents are not perfectly balanced, a small excess of positive current could be enforced, and a small low-power cathode may be used to reach full neutrality.

In some embodiments, the thruster head may be biased negatively with respect to the extractor, such that negatively charged bubbles may be created in the stream. This configuration can be advantageous if operating in the relatively dense ionosphere of low earth orbit in cases where the electron saturation current of the local plasma is sufficiently high to neutralize a spacecraft attempting to charge positively. This point would be applicable to any EP propulsion system capable of emitting negative charges.

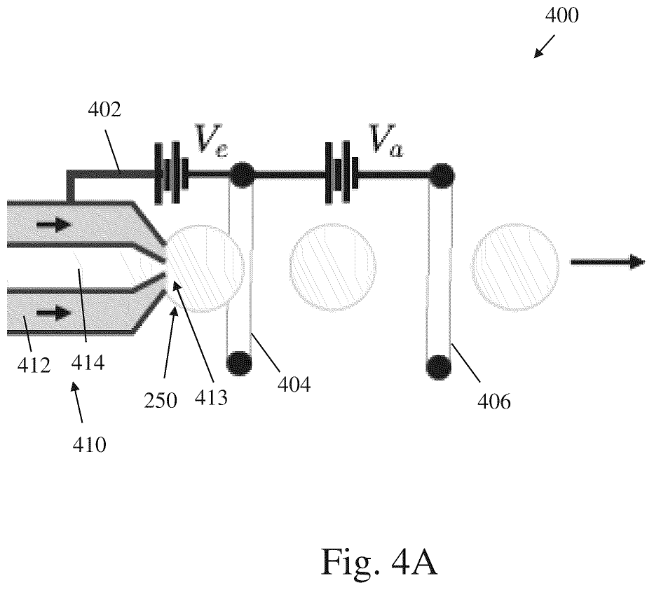

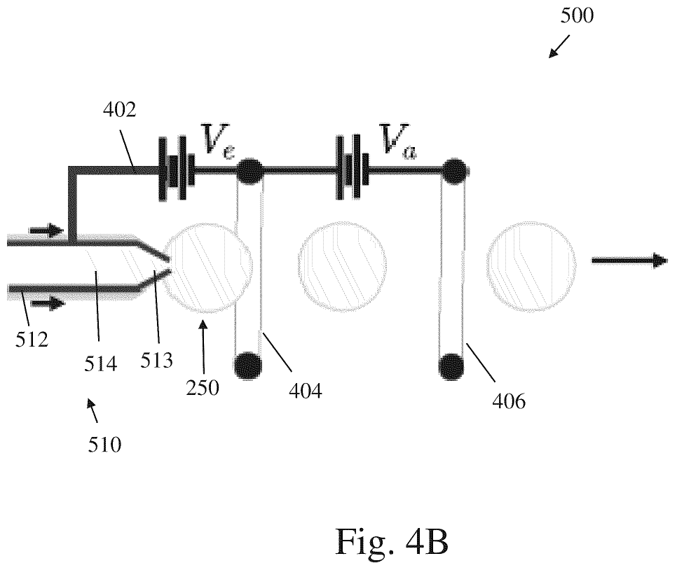

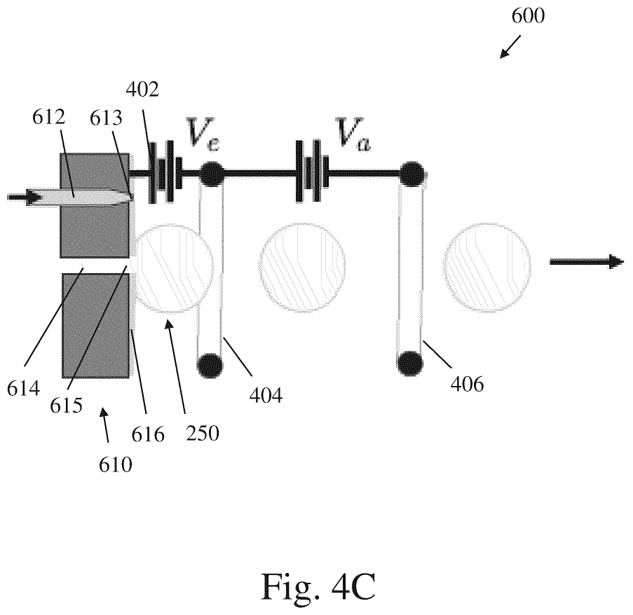

FIGS. 4A-4C depict schematic illustrations of electric thrusters configured to capacitively charge bubbles according to different embodiments. For example, FIGS. 4A-4C each depict a schematic representation of an electric thruster comprising a different type of sprayer configured to generate charged bubbles. FIG. 4A depicts a schematic illustration of an electric thruster 400 which comprises at least one coaxial sprayer 410. In some embodiments, the at least one coaxial sprayer 410 comprises a core channel 414 configured to flow gas from a gas source (e.g., such as the gas source 304) and an exterior channel 412 at least partially surrounding the core channel 414. The exterior channel 412 can be configured to flow liquid from a liquid source (e.g., such as the liquid source 302) to a distal outlet 413 of the exterior channel 412. The liquid can be an electrically conductive liquid as describe above.

In some embodiments, the electric thruster 400 may comprise an electrode 402 in electrical contact with the at least one coaxial sprayer 410 and a first counter electrode 404 that is at a first potential difference Ve. Accordingly, the electrically conductive liquid flowing in the exterior channel 412 can be charged by the electrode 402. As the gas and the electrically conductive liquid flow through an outlet 413 of the at least one coaxial sprayer 410, a charged bubble 250 can be formed and move towards the first counter electrode 404. When the charged bubble 250 detaches, the surface 252 of the charged bubble 250 can have behave as a capacitor. In some embodiments, the electric thruster 400 may comprise a second counter electrode 406 biased to a second potential difference Va with respect to the first potential Ve of the first counter electrode 404. Accordingly, the charged bubble 250 can be further accelerated. As a result, the coaxial capacitive bubble generator 400 can generate a stream of capacitively charged bubbles 250 which are accelerated to generate thrust.

FIG. 4B depicts a schematic representation of an electric thruster 500 according to some embodiments. The electric thruster 500 depicted in FIG. 4B has many similar components as the coaxial capacitive bubble generator 400 of FIG. 4A which are indicated by the same reference labels. As seen in FIG. 4B, in some embodiments, the electric thruster 500 may comprise at least one sprayer 510 having an interior channel 514 configured to flow gas (e.g., under pressure from gas source 304). The conductive liquid can wet an exterior surface 512 of the at least one sprayer 510. Accordingly, the conductive liquid can be externally fed along the exterior surface 512. Since the exterior surface 512 is in electrical contact with the electrode 402, the conductive liquid can receive a corresponding charge from the electrode 402. The electrically conductive liquid may therefore flow toward a distal end 513 of the at least one sprayer 510 and generate charged bubbles 250. In some embodiments, the conductive liquid may flow to the distal outlet 513 under capillary action. For example, the conductive liquid may be wicked along the exterior surface 512 toward the opening of the at least one sprayer 510. At the distal outlet 513, charged bubbles 250 can be formed having a capacitive charge which move towards the first counter electrode 404 and the second counter electrode 406 as described previously above. Accordingly, the electric thruster 500 can form and accelerate a stream of charged bubbles 250 to generate thrust.

FIG. 4C depicts an electric thruster 600 according to some embodiments. In the depicted embodiment, a conductive liquid forms a liquid layer on an exterior surface 616 of an at least one sprayer 610. In some embodiments, one or more openings may extend through the exterior surface 616 of the at least one sprayer 610. For example, in the depicted embodiment, a liquid channel 612 may provide a flow path for the conductive liquid between a liquid source (e.g., the liquid source 302) and the exterior surface 616 such that the liquid source may be in fluid communication with the exterior surface 616. Accordingly, in some embodiments the conductive liquid can be supplied from the liquid source to the exterior surface 616 through a liquid opening 613. Of course, the conductive liquid may wet the exterior surface 616 in any desired manner as the disclosure is not so limited. In the embodiment of FIG. 4C, a gas channel 614 can provide a flow path between a gas source (e.g., the gas source 304) and the exterior surface 616 such that the gas source is in fluid communication with the exterior surface 616 through a gas opening 615. As described above, the exterior surface 616 can be in electrical contact with the electrode 402 such that the conductive liquid acquires an electrical charge. As a result, the gas can flow from the gas opening 615 to form capacitively charged bubbles 250 which can be accelerated as described above using the first and/or second counter electrodes 404, 406 to produce thrust.

While the depicted embodiment shows one liquid opening 613 and one gas opening 615, it is appreciated that the electric thruster 600 according to embodiments disclosed herein may comprise any number of liquid openings 613 and/or gas openings 615 as the disclosure is not so limited. For example, in some embodiments, the electric thruster 600 may comprise a plurality of gas openings 615 extending through the exterior surface 616 of the at least one sprayer 610. In some embodiments, the electric thruster 600 may comprise a plurality of liquid openings 613 extending through the exterior surface 616 of the at least one sprayer 610. As a result, in some embodiments, the electric thruster 600 may comprise an array of openings extending through the exterior surface 616. Such openings may be arranged in any configuration as desired (e.g., a grid pattern, an offset grid pattern, etc.).

It is contemplated that such wetting may occur passively. In this regard, the exterior surface 512 may have a fluid affinity greater than that of the fluid supply line. To achieve a desired fluid affinity, in some embodiments, the exterior surface 512 of the at least one sprayer 510 and/or the exterior surface 616 of the at least one sprayer 610 can be engineered (e.g., by surface conditioning, texturing, and/or structuring) as would be appreciated by those of skill. It is also appreciated the exterior surfaces 512, 616 can be wetted under pressure. For example, in some embodiments, a liquid feed line (not shown) and/or liquid opening 612 may supply the conductive liquid under pressure to the exterior surfaces 512, 612. Such a configuration may be beneficial to ensure that the conductive liquid is fed to the exterior surfaces 512, 612.

### Example: Comparison of Existing and Proposed Thruster Operational Regimes

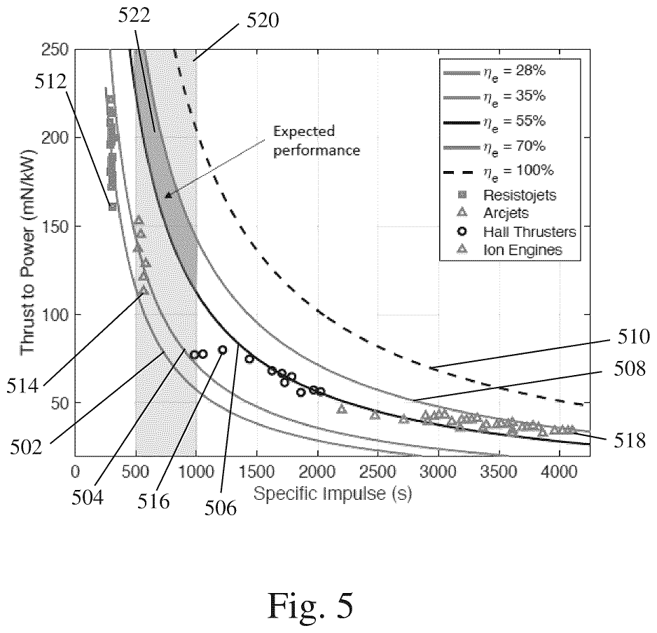

A comparison between existing and proposed thruster operation is discussed further with reference to FIGS. 5-12.

Thrust-to-power depends on engine efficiency ηₑ and Iₛₚ=c/g, where c is the ideal exhaust velocity (assumed constant) and g is earth's gravitational constant,

$$\frac{F}{P} = 2 \frac{{η}_{e}}{c} \qquad ( 1 )$$

FIG. 5 shows thrust-to-power as a function of Iₛₚ at different efficiencies. In the FIG. 5, a curve 502 is ηe=28%, a curve 504 is ηe=35%, a curve 506 is ηe=55%, a curve 508 is ηe=70%, and a curve 510 is ηe=100%. Symbols represent data from several types of electric propulsion technologies. For example, squares 512 represent resistojets, triangles 514 represent arcjets, circles 516 represent hall thrusters, and triangles 518 represent ion engines. The region of 500-1000 s seen at 520 in Iₛₚ is currently not well covered by existing EP and it would be beneficial to have an efficient (ηe>50%) technology covering it. A significantly higher F/P may be obtained, in some cases by a factor of 2× to 3× compared to the propulsion options outside of this range. Such improvements may be quite advantageous in the design and deployment of space assets, for example by allowing shorter thrusting times or by decreasing the size requirements of power subsystems. While we emphasize the particular benefits of operating in the 500-1000 s range, the proposed approach may allow operation at different values and ranges of Iₛₚ. Expected performance of the proposed approach in the region of 500-1000 s can be seen at a region 522 between the curves 506, 508.

Electrospraying is a technique that is routinely used to produce streams of highly charged liquid droplets. The most common implementation makes use of a capillary emitter (usually just a very narrow tube) that carries a conductive liquid towards its exit, where a strong electric field is applied to deform the liquid into a cone-like structure. The apex of this structure then deforms further into a slender charged jet that eventually breaks up into a collection of nearly monodisperse charged droplets of characteristic radius r. The charging efficiency of droplets in this “cone-jet” regime may be quite high, as they are created in a state where the charges on their surface produce an outward force very close to the surface tension inward force, which keeps the droplet together. When these two forces are equal, the droplet becomes unstable and breaks apart. Such condition is known as the Rayleigh limit and establishes the absolute, unperturbed, maximum charge that can exist on a liquid droplet. In most cases, stable cone-jet electrosprays produce droplets that are charged to about ½ of the Rayleigh limit, q_{R}

$$q = \frac{1}{2} {q}_{R} = 4 π \sqrt{{γε}_{0}} {r}^{3 / 2} \qquad ( 2 )$$

where q is the droplet charge, γ is the liquid surface tension and ε₀ is the permittivity of vacuum. This represents the most effective way of charging liquids to achieve the highest possible specific charge,

$$\frac{q}{m} = \frac{3 \sqrt{{γε}_{0}}}{ρ {r}^{3 / 2}} \qquad ( 3 )$$

where ρ is the mass density of the liquid and m is the droplet mass. Despite this, the values of specific charge are still relatively low to obtain the desired Iₛₚ range at moderate acceleration voltages. This has motivated research into obtaining extremely small droplets, just a few tens of nanometers in diameter. This may be achieved by using liquids of high electrical conductivity and operating the electrospray at very low flow rates, thus increasing the specific charge of the resulting charged droplets. However, when dimensions are as small as that, the magnitude of the electric fields generated at the liquid-vacuum interface can become sufficiently strong to produce copious direct ion evaporation from the liquid surface, thus creating a mixed spray of charged droplets and ions. The issue is that ions are much lighter than droplets and carry most of the electric current, whereas droplets, which are much heavier, carry most of the liquid mass. This results in very poor energy conversion efficiency, with only marginal benefits in Iₛₚ. In fact, efficiency is maximized only for pure droplet or pure ion beams.

A possible solution of this problem would be to find a conductive liquid formulation that has an extraordinarily high free energy of ion evaporation, such that ions are not produced even when the liquid is exposed to the kind of electric field magnitudes that result from nano-sized droplets. The search of such substances has come, so far, empty handed.

As detailed above, as disclosed herein, a variation of electrospray technology in the cone-jet mode has been developed, where an immiscible gas core is contained within a charged shell of a conductive liquid, thus forming charged bubbles. For operation in vacuum, the liquid for the shell may be a zero-vapor pressure ionic liquid, which is commonly used in other types of electrospraying. The main benefit of this configuration comes from a significantly lower mass of the bubble when compared with a droplet of the same size, thus boosting the specific charge. This modification would allow the specific impulse to increase without decreasing the particle size, thus ensuring operation in the pure droplet regime. Bubbles are accelerated to a velocity c that depends on their specific charge q/m and the applied voltage V,

$${I}_{sp} = \frac{c}{g} = \frac{1}{g} \sqrt{2 \frac{q}{m} V} \qquad ( 4 )$$

Preventing ion emission may be desirable, otherwise the efficiency may drop dramatically due to the significant polydispersive losses that appear in mixed beams. It was assumed that the current density carried by ion evaporation may be described as a field-assisted activated process with an energy barrier determined by the image-charge model,

$$j = σ \frac{kT}{h} exp [ - \frac{1}{kT} ( Δ G - {( \frac{{q}^{3} E}{4 {πε}_{0}} )}^{1 / 2} ) ] \qquad ( 5 )$$

where σ is the surface charge density, h is Planck's constant, k is Boltzmann's constant and T the surface temperature. Copious ion emission can be expected when the electric field becomes of magnitude,

$$E = {E}^{*} \approx \frac{4 {πε}_{0}}{{q}^{3}} Δ {G}^{2} \qquad ( 6 )$$

Since the free energy of ion evaporation ΔG˜1 eV, the critical field for ion emission becomes of order 109 V/m. The characteristic dimension of the emission region can be estimated through a mechanical balance between electric and surface tension stresses,

$$\frac{1}{2} {ε}_{0} {E}^{* 2} \approx \frac{2 γ}{{r}^{*}} \qquad ( 7 )$$

From here, this characteristic size is about r* of approximately 10 nm. It is expected that when droplets are of this size, ion emission may be substantial (ions are evaporated from the cone-jet transition region and from the droplets themselves). The exponential dependence on the field for the rate of ion emission is quite sensitive, especially since ΔG>>kT. For instance, if the field drops 90% from its E* value, ion emission would not occur in any appreciable way. At this level, the droplet size may need to be increased by a factor of 100, to one micron, or slightly sub-micron sized droplets. This is typically observed in cone-jet electrosprays at relatively large flow rates, which often display a spray composition formed exclusively of droplets. The critical dimension at which ion emission would occur depends on many variables, and needs to be carefully characterized for specific liquids and operating conditions. For the moment it is safe to assume that relatively large droplets, on the order of 0.25 to 1 micron, are unlikely to produce meaningful ion evaporation.

For purposes of this example, it was assumed that a charged droplet has diameter of 0.5 microns, so that r=2.5×10⁻⁷ m. For a typical ionic liquid γ=0.05 N/m and ρ=1200 kg/m³. The specific charge of such a droplet would be,

$$\frac{q}{m} = \frac{3 \sqrt{{γε}_{0}}}{ρ {r}^{3 / 2}} = 13 C / kg$$

Assuming an acceleration potential of 10 kV, the specific impulse of an EP system based on these droplets would be only 52 sec. This is not that different from existing cold gas thrusters, although such electrospray system would be certainly more complex. The efficiency of this propulsion system would be quite high since only nearly mono-disperse droplets would be produced, but the performance as a thruster would be far too low at Iₛₚ=52 s to be of practical interest. This in fact was the main barrier to the implementation of colloid thrusters back in the late 1960's and early 1970's, as voltages larger than 10 kV were needed to obtain a specific impulse that would be competitive with the also novel ion engines developed in parallel. Increasing the Iₛₚ tenfold to about 500 s at 10 kV or less would require at least a corresponding 100-fold reduction in droplet mass. This seems possible for a bubble with a thin liquid shell.

As described herein bubbles may be produced through the use of coaxial electrospraying. The use of zero-vapor pressure ionic liquids or other appropriate low vapor pressure liquids may be desirable to prevent immediate bursting of bubbles through the evaporation of their thin liquid shell when implemented in vacuum.

In a similar way to the conventional production of charged droplets in cone-jet electrosprays, it was assumed that bubbles may be charged to about ½ the Rayleigh limit,

$$q = 4 π \sqrt{2 {γε}_{0}} {{r}^{3 / 2} ( 1 - \frac{δ}{2 r} )}^{1 / 2} {( 1 - \frac{δ}{r} )}^{- 1 / 2} \qquad ( 8 )$$

The mass of the bubble consists of the mass of the liquid shell plus the mass of the gas core,

$$m = \frac{4}{3} πρ {r}^{3} [ 1 - {( 1 - \frac{δ}{r} )}^{3} ( 1 - \frac{{ρ}_{g}}{ρ} ) ] \qquad ( 9 )$$

where ρg is the mass density of the gas core. Defining β=δ/r, the parametrized specific charge of the bubble can be written as,

$$\frac{q}{m} = \frac{3 \sqrt{2 {γε}_{0}} {( 1 - \frac{1}{2} β )}^{1 / 2} {( 1 - β )}^{- 1 / 2}}{ρ {r}^{3 / 2} [ 1 - {( 1 - β )}^{3} ( 1 - {ρ}_{g} / ρ ) ]} \qquad ( 10 )$$

Since relevant propulsive quantities, like thrust and specific impulse, depend on the square root of the specific charge, an augmentation factor α can defined by taking the square root of the ratio of Eq. (10) to Eq. (3),

$$α = \frac{{( 2 - β )}^{1 / 4} {( 1 - β )}^{- 1 / 4}}{{[ 1 - {( 1 - β )}^{3} ( 1 - {ρ}_{g} / ρ ) ]}^{1 / 2}} \qquad ( 11 )$$

This factor then describes the degree to which the use of bubbles would increase Iₛₚ when compared against the acceleration of charged droplets of the same size.

While the liquid mass density ρ is practically constant, the gas density ρg will depend itself on the droplet size and gas properties. Assuming ideal gas, the density is,

$${ρ}_{g} = \frac{p}{{R}_{g} T} = \frac{M}{T} \frac{4 γ ( 1 - \frac{1}{2} β )}{1 - β} \frac{1}{r} \qquad ( 12 )$$

where [symbol] is the universal gas constant, M is the molecular mass of the gas, T is its temperature and p is the gas pressure, which in a vacuum is equal to the pressure difference across the liquid shell. At high pressures (small r), the gas density could be substantial, so there may be an interest in using a core gas that is as light as possible.

To make the connection between bubble properties and electrospray operational conditions, we calculate the specific charge, again, but this time using the current and mass flow rate produced by the coaxial device,

$$\frac{q}{m} = \frac{I}{\dot{m}} = \frac{I}{ρ {Q}_{l} + {ρ}_{g} {Q}_{g}} \qquad ( 13 )$$

where I is the cone-jet current and Q₁ and Q_{g} are the volumetric flow rates for the liquid and gas, respectively. The current can be obtained from the universal scaling law,

$$I = f ( ε ) \sqrt{\frac{γ KQ}{ε}} = f ( ε ) \sqrt{\frac{γ {KQ}_{l} ( 1 + \frac{{Q}_{g}}{{Q}_{l}} )}{ε}} \qquad ( 14 )$$

where the electric conductivity K and surface tension γ are referred to the liquid in the shell, and f(ε) is an empirical factor that depends on the liquid's dielectric constant ε. This is justified since both are surface properties, assuming full electrical relaxation.

The parameter β is selected by adjusting the relative flow rates of the shell and the core. In practice this can be done by using flow controllers at fixed pressure, or by adjusting independently the feeding pressures of the shell and core flow lines. Regardless, the ratio of volumetric flow rates equals the ratio of the core and shell volumes, such that,

$$\frac{{Q}_{g}}{{Q}_{l}} = \frac{{V}_{g}}{{V}_{l}} = \frac{{( 1 - β )}^{3}}{1 - {( 1 - β )}^{3}} \qquad ( 15 )$$

Also, it is useful in electrospray analysis to write the volumetric flow rate in terms of the non-dimensional flow parameter (ρ′ is the mass-averaged density),

$$η = \sqrt{\frac{{ρ}^{′} KQ}{{γεε}_{0}}} = \sqrt{\frac{ρ {KQ}_{l} ( 1 + \frac{{ρ}_{g}}{ρ} \frac{{Q}_{g}}{{Q}_{l}} )}{{γεε}_{0}}} \qquad ( 16 )$$

Using these expressions, and making Eq. (10) equal to Eq. (13), an equation that relates the flow parameter η to the bubble radius r may be defined as follows,

$$\frac{η}{K} = \frac{{[ 1 - {( 1 - β )}^{3} ( 1 - {ρ}_{g} / ρ ) ]}^{1 / 2}}{{( 1 - \frac{1}{2} β )}^{1 / 2} {( 1 - β )}^{- 1 / 2}} ( \frac{f}{{εε}_{0}} ) {( \frac{ρ}{18 γ} )}^{1 / 2} {r}^{3 / 2} \qquad ( 17 )$$

Notice that in Eq. (17), the core gas density is ρg=ρg(r), as given by Eq. (12). Stable electrosprays operate with flow rates that correspond to values of η from about 1 to 10. It is therefore desirable to verify that within that range of flow rates, bubble sizes that will not produce ion emission may be obtained while delivering the desired propulsive performance.

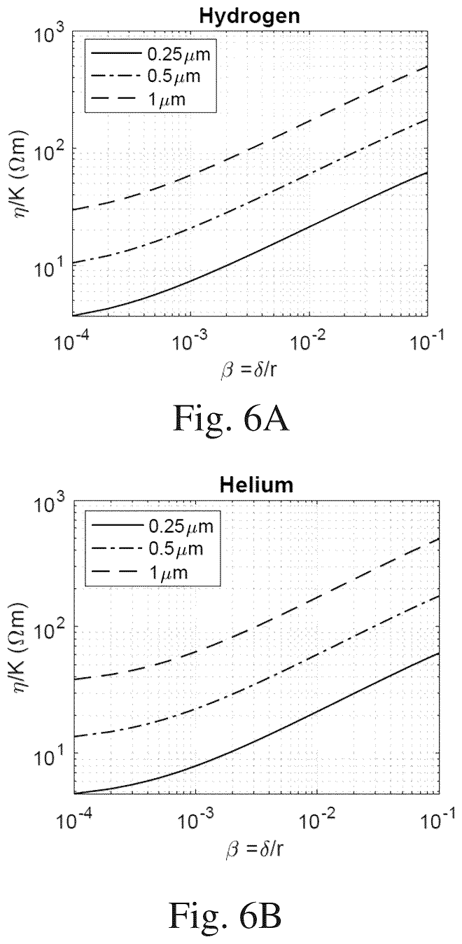

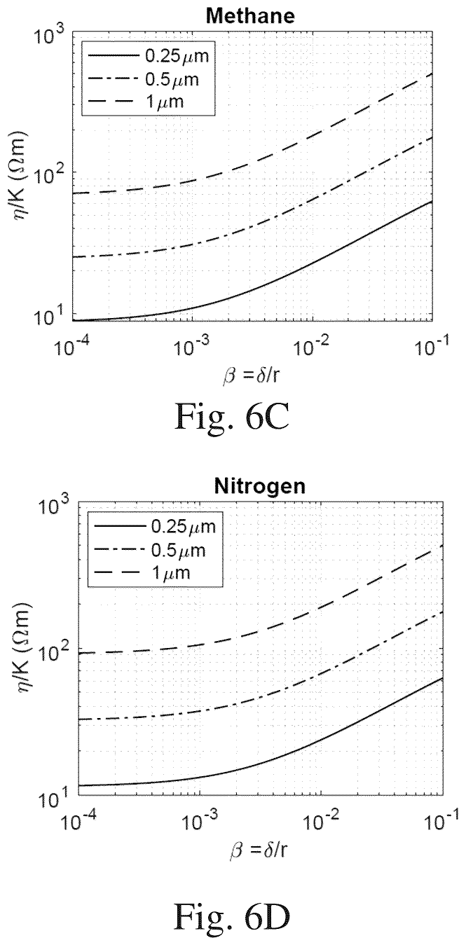

FIGS. 6A-6D display a dependence of η/K as a function of β for different bubble sizes (diameter) and different core gases. In Eq. (17) η/K is expressed as a function of r, since any given droplet size could be in principle obtainable for a wide range of values of η and K. However, since η∈[1, 10], the variation of electrical conductivity could be quite substantial, spanning several orders of magnitude. Fortunately, there is a wide variety of ionic liquids with such a large variation, thus giving significant flexibility in the selection of liquid properties and operational conditions.

The observed values of η/K span about one order of magnitude for a given bubble size in a wide range of β. The actual value could be quite different, from about η/K=3.5 Ωm for the smallest β and r with hydrogen, to about η/K=500 Ωm for the largest β and r with nitrogen. The flexibility of choosing K, even for ionic liquids, over a wide range of values enables operation in a flow rate that comfortably yields pure droplet emission. For example, if an electrospray producing bubbles with η=5 was used, the conductivity may be about K=1.4 S/m or K=0.01 S/m, respectively for the cases described above. These are close to the respective room temperature electrical conductivities of EMI-BF4 and EMI-MSI, two common, non-volatile ionic liquids.

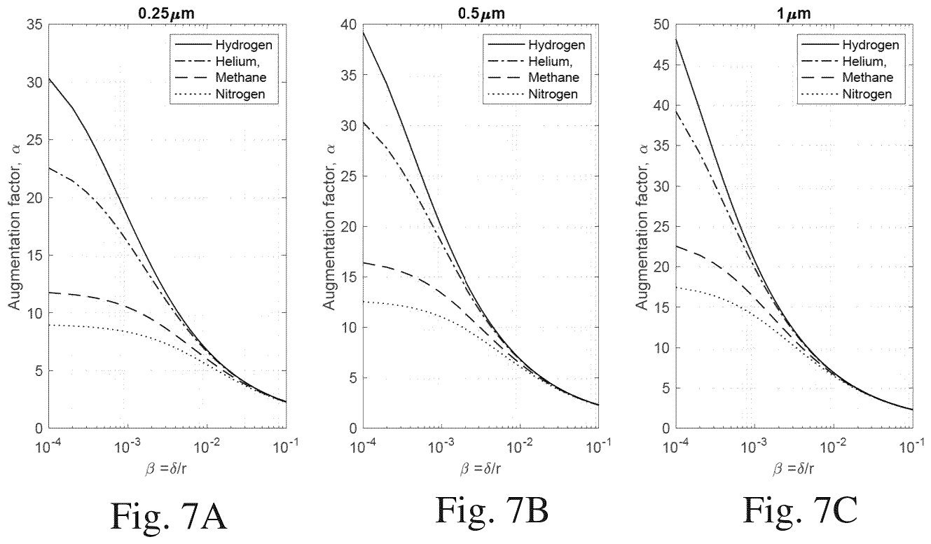

FIGS. 7A-7C show the augmentation factor α as calculated from Eq. (11) for the same range of β and core gases. For all values shown, there was, as expected, a net gain when using bubbles over droplets in specific impulse of at least α=2.3 for the largest β and up to nearly α=50 with hydrogen for the smallest β and largest bubble size. It is interesting to note that the sensitivity to gas composition becomes important for small β as the mass of the gas core increases relative to the mass of the liquid shell. These results also suggest that obtaining at least a 10× improvement over charged droplets is possible for a wide range of bubble dimensions, operating conditions, and selection of ionic liquids and core gases.

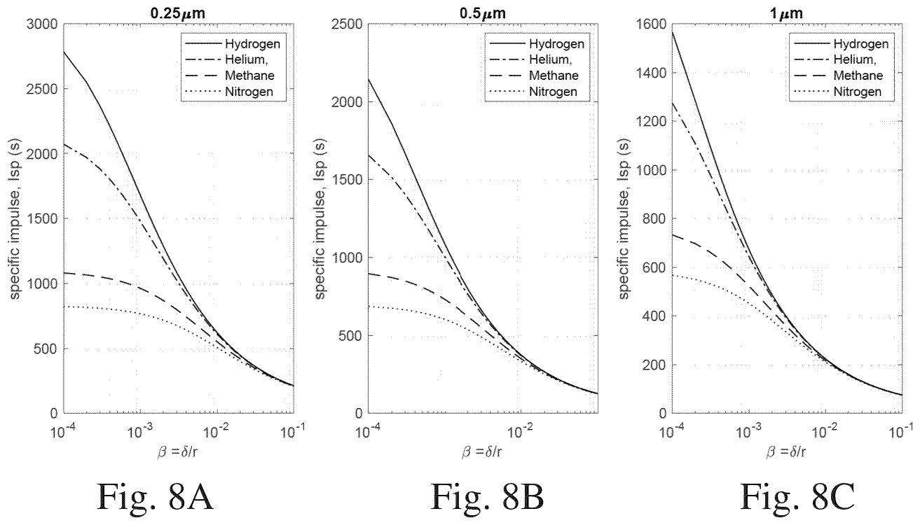

The specific impulse can be calculated from Eqs. (4), (10) and (12) and it is shown for different bubble sizes at an acceleration voltage of V=10 kV in FIGS. 8A-8C. This figure emphasizes the degree to which the performance of a thruster based on bubbles may improve over a regular colloid thruster. It also shows that the highest benefit may be reached when β has very small values and a lighter core gas, even though significant benefit would already be obtained for larger values of β, as the core gas composition becomes less relevant. In any event, this suggests that the design of a thruster that operates at high efficiency with a Iₛₚ-500-1000 s is quite possible with voltages ≤10 kV

The thrust produced by a bubble emitter is,

$$F = \dot{m} c = \frac{I}{q / m} \sqrt{2 \frac{q}{m} V} = I \sqrt{\frac{2 V}{q / m}} \qquad ( 18 )$$

Without wishing to be bound by theory, at a fundamental level, the thrust produced by an accelerating bubble scales with its change of momentum, but as the mass of the bubble decreases (at constant charge), we expect its velocity to increase, thus, for a given flow rate parameter, it may be expected the thrust to remain more or less constant. This is more clearly shown when using Eqs. (10), (14) and (16) to write the thrust as,

$$F = \dot{m} c = {( \frac{2}{9} {ε}_{0} {γ}^{8} {V}^{2} )}^{1 / 4} \frac{f η {r}^{3 / 4}}{{( 1 - \frac{1}{2} β )}^{1 / 4} {( 1 - β )}^{- 1 / 4}} \qquad ( 19 )$$

It may be observed that Eq. (19) has only a weak dependence on β, especially when β<<1, so we could in principle neglect its contribution for a fixed r by taking (1−½β)¼(1−β)−¼≈1. It may be noticed that a similar weak dependence for the bubble charge may be seen in Eq. (8). This is because the electric stress balances the surface tension pressure of the two curved surfaces on the liquid shell. Other than in cases where the bubble is almost all liquid, these two curvatures are quite similar. In fact, the main effect in changes of q/m and Iₛₚ comes from changes in mass given by Eq. (9), which are quite sensitive to β. This in fact shows that by using bubbles, the amount of thrust is just slightly lower than in regular colloid thrusters for any β because of the larger pressure in a bubble compared to a droplet of the same size, thus allowing more charge to be deposited on its surface, increasing the specific charge by a factor of √2 and decreasing thrust by a factor of 2¼.

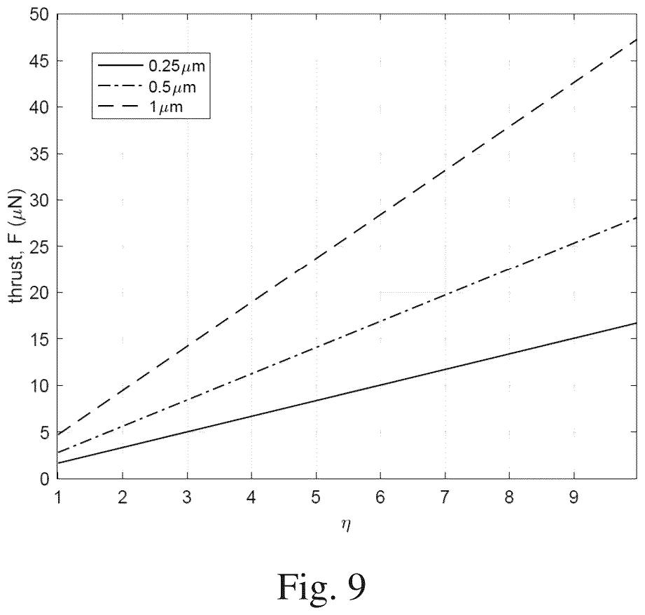

FIG. 9 shows the thrust as a function of the non-dimensional flow parameter f. Notice that Eq. (19) is written as a function of r and f, and these two variables are connected by Eq. (17). Because of this, FIGS. 8A-8C are only notional, as other things need to change to keep the bubble size constant at different flow rates (the liquid properties, for example) and those changes may be sensitive to β. It nevertheless shows that for the sizes of bubbles considered, thrust at the 10's μN level may be obtained in the desired range of specific impulse from a single emitter. To explore this in more detail, thrust calculations were performed taking the full dependencies in consideration as detailed below.

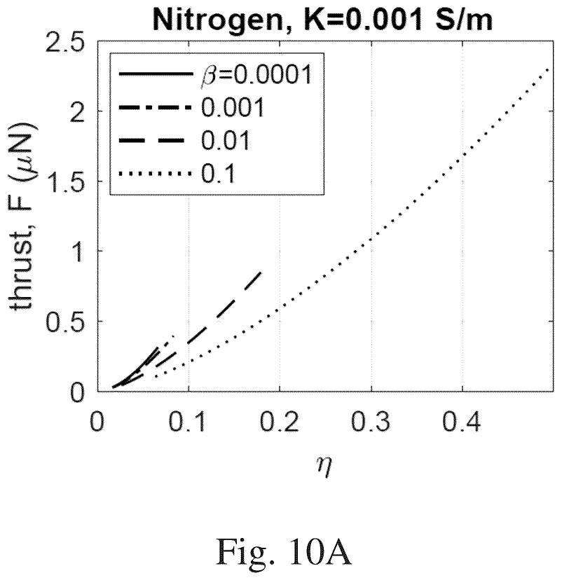

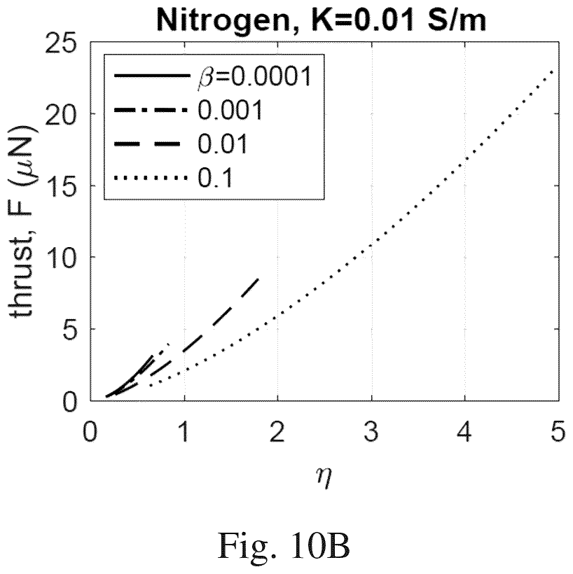

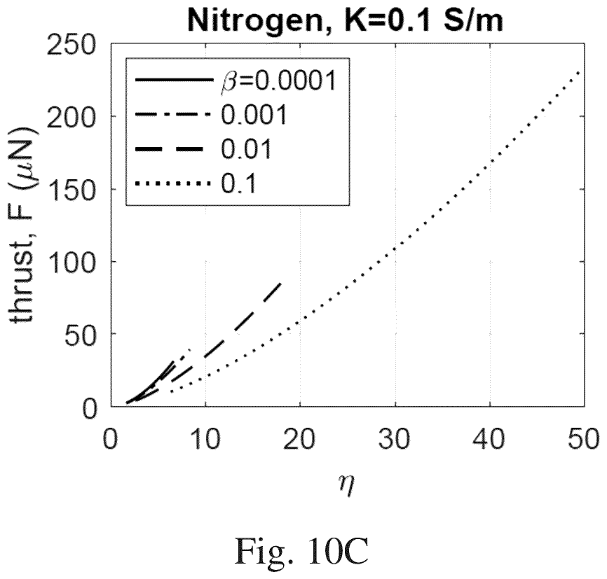

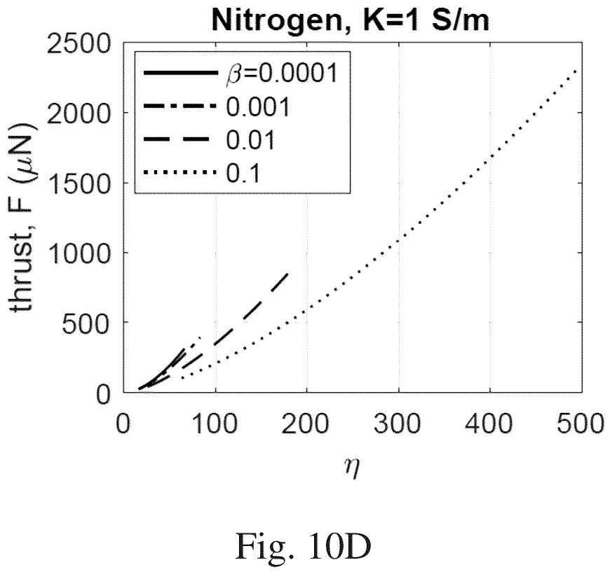

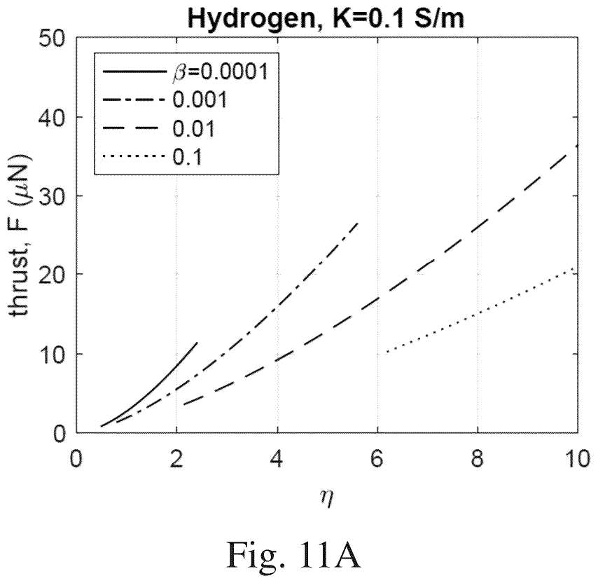

FIGS. 10A-10D display the way in which the thrust varies with the non-dimensional flow parameter η for nitrogen as the core gas and different values of β and electrical conductivity of the shell liquid. The flow rate modifies the bubble size according to Eq. (17), such that the range of each curve spans a bubble size (diameter) from 0.25 μm (left end) to 1 μm (right end). This figure suggests that very low and very high conductivities may be problematic in practice since η could easily fall outside of η∈[1, 10]. The main issue is that very low K may result in high flow rates to get into that range, producing larger bubbles with lower Isp. On the other hand, very high K may result in low flow rates to get into the range, creating very small bubbles that could lead to ion evaporation.

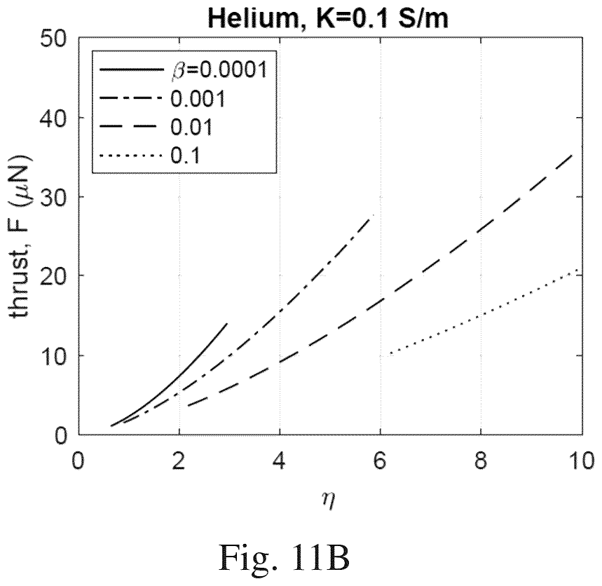

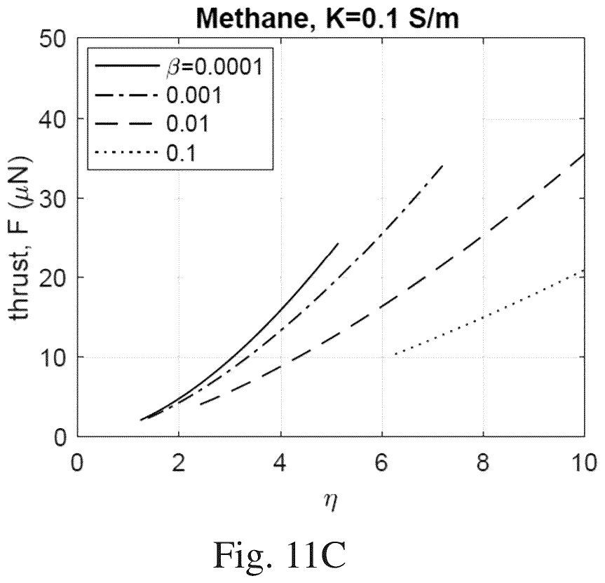

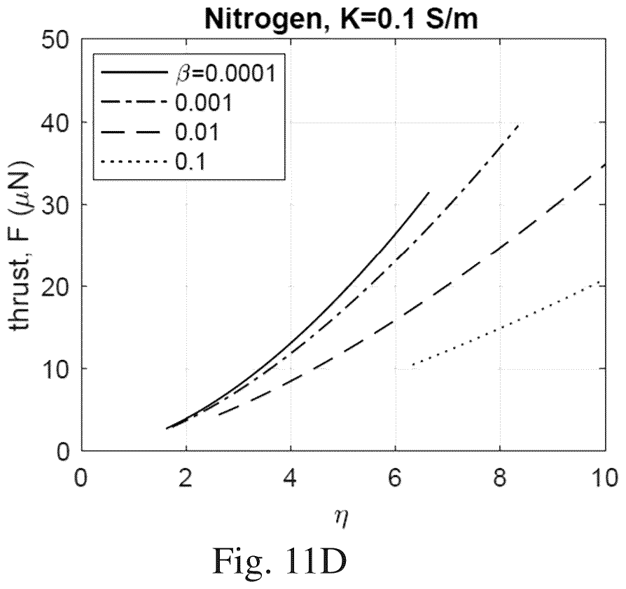

While both situations could be remedied by adjusting other factors, a more comfortable solution would be to select an intermediate conductivity that would make η fall more naturally in η∈[1, 10]. For example, FIGS. 11A-11D show results for K=0.1 S/m, including variations in β and core gas. This suggests that stable operation would be possible for a liquid with such conductivity (it is easy to find an ionic liquid with almost any conductivity, in this case, this would be CF₃CH₂MeIm-Tf₂N), where the different curves indicate different thruster performance, according to the analysis presented here.

As with any other electrospray, the thrust indicated in these figures is per emitter, which is a single coaxial tube. Most electrospray thrusters are by now designed as arrays of emitters fabricated with a variety of techniques. It is expected that this concept would also be amenable for fabrication in clusters of multiple emitters to increase the thrust level to what is required by a particular mission. For example, assuming a thrust per emitter of 10 μN, a square array of emitters spaced out by about 3 mm would produce the same thrust density as a high power ion engine (about 1 Nm⁻²). Reducing that spacing to 1 mm would increase the thrust density to what is obtained in a typical Hall thruster (about 10 Nm⁻²). Most electrospray thruster arrays feature spacings smaller than 1 mm, sometimes in the 10's of m, thus suggesting that the fabrication of high-density propulsion devices using this concept would be in principle possible and would be quite advantageous.

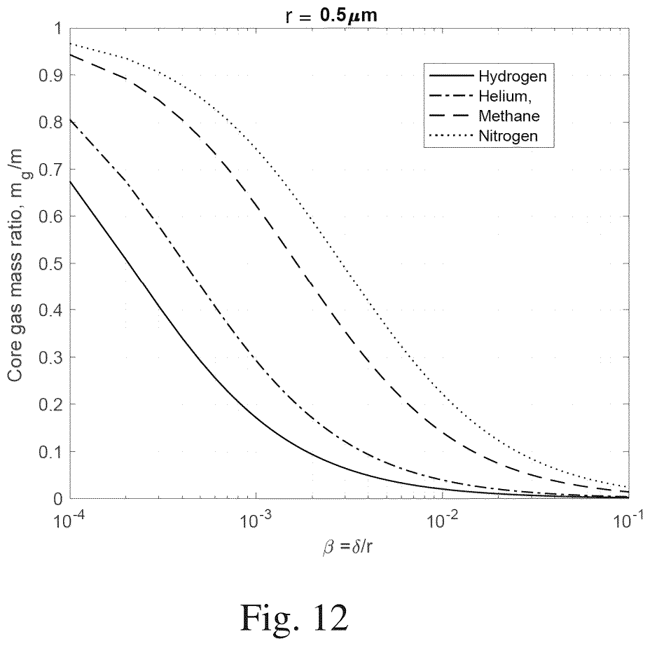

This disclosed concepts may involve the use of a propellant management system capable of storing and delivering the ionic liquid and the core gas. The relative amount of these two propellants depends on the operational conditions and the fluid properties. The core gas to total mass ratio is given by,

$$\frac{{m}_{g}}{m} = \frac{{( 1 - β )}^{3} {ρ}_{g} / ρ}{1 - {( 1 - β )}^{3} ( 1 - {ρ}_{g} / ρ )} \qquad ( 20 )$$

where the gas density ρg is given by Eq. (12). FIG. 12 shows these dependencies for the same set of core gas options and assuming a bubble size of 0.5 μm.

It can bee seen from FIG. 12 that over a wide range of β values, the propellant masses are quite evenly distributed. Only in cases where β is very small or large, one type of propellant would dominate over the other. In either case, the system may be appropriate configured to manage both propellants effectively.

### Example: Capacitive Charging of a Bubble

The core idea behind capacitive charging according to embodiments disclosed herein is to use an electric field to accelerate charged liquid bubbles to produce thrust. One benefit of this approach is that bubbles should be able to accumulate sufficient charge on their surface, while reducing the mass on their volume, to produce a stream of charged particles that have improved momentum transfer properties. This would allow the specific impulse to be high at relatively low acceleration voltages, while the high efficiency of the method can enable high thrust to power operation well beyond existing technologies.

The proposed concept could use any form of liquid bubble charging. In some embodiments disclosed herein, we teach use electrospraying to produce a coaxial stream of gas encapsulated by a non-volatile ionic liquid. Even though electrospraying is an excellent method to charge liquid droplets near their stability limit (Rayleigh limit), it is not the only method available, especially in situations where relatively large bubbles with very thin liquid layers could be produced.

Accordingly, another charging method am comprise using capacitive coupling (through polarization) to deposit charge on a liquid bubble. Some schematic configurations are shown in FIGS. 4A-4C. With capacitive charging, bubbles can be created by applying a back pressure, as opposed to the electric traction that dominates the extraction of liquid in electrospraying.

In some embodiments, this can be achieved by the flow of gas and liquid through a coaxial tube as seen in FIG. 4A. The liquid could also flow on the outside of the tube transporting the gas as seen in FIG. 4B. Another option is for the liquid to wet a surface with holes forming a thin layer, while gas is pushed through the holes to form bubbles as seen in FIG. 4C. Some configurations may have the liquid directly exposed to vacuum. however, since the ionic liquid has zero vapor pressure, the ionic liquid may not be lost through evaporation. In the embodiments of FIGS. 4A-4C, the bubbles can be formed on a surface in electric contact with an electrode and can move towards a counter-electrode until it detaches.

In the embodiments of FIGS. 4A-4C, there is a potential difference Ve applied between these two electrodes. As such, the surface of the conductive droplet behaves as a capacitor. Further bubble acceleration could be provided by adding another counter-electrode and biasing it to a voltage Vₐ with respect to the first counter-electrode. Charge can be polarized on the surface of the liquid and when it detaches, the droplet may acquire a capacitive charge q_{c}=CVₑ. Assuming ideal behavior of a capacitive sphere,

$${q}_{c} = 4 {πε}_{0} r {V}_{e} \qquad ( 21 )$$

In this example, the liquid film thickness is assumed to be very small compared to the bubble radius (δ<<r). Under these conditions, we can compare Eq. (21) with the bubble charge q_{R} corresponding to ½ of the Rayleigh limit which is obtainable with electrosprays,

$${q}_{R} = 4 π \sqrt{2 {γε}_{0}} {r}^{3 / 2} \qquad ( 22 )$$

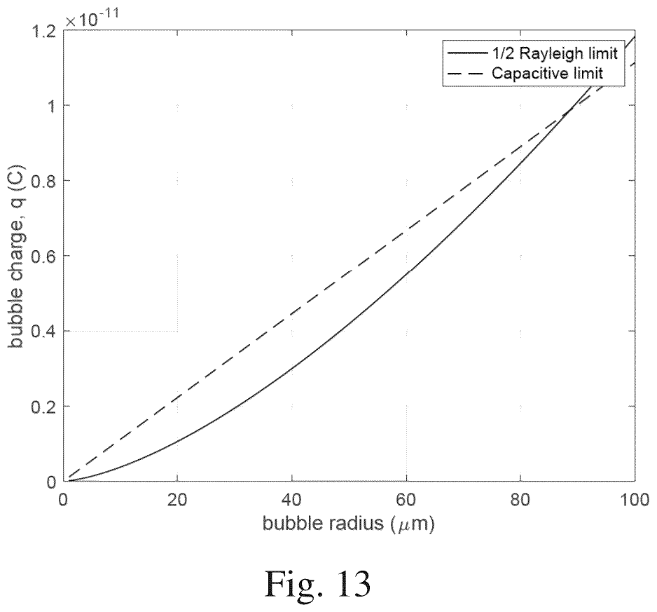

FIG. 13 shows the comparison of these limits when the capacitive charging of a bubble occurs at 1000 V according to some embodiments. The condition δ<<r should be met, especially at the large end of bubble sizes. The bubble mass could then be close to that of the enclosed gas. Any correction to the mass due to the liquid layer could be identical in both cases. In effect this means that the specific charge of the bubbles can be on the same order with both methods, and their propulsive performance could be similar.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device including one or more processors may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

1. An electric thruster comprising:
at least one coaxial sprayer, wherein each coaxial sprayer of the at least one coaxial sprayer includes a core channel and an exterior channel at least partially surrounding the core channel;
a liquid source configured to contain a liquid and in fluid communication with the exterior channel of each coaxial sprayer of the at least one coaxial sprayer;
a gas source configured to contain a gas and in fluid communication with the core channel of each coaxial sprayer of the at least one coaxial sprayer;
an upstream electrode configured to apply a voltage potential to the liquid flowing from the liquid source to the at least one coaxial sprayer; and
an extractor electrode configured to accelerate bubbles comprising the gas and the liquid emitted from the at least one coaxial sprayer.

2. The electric thruster of claim 1, wherein the at least one coaxial sprayer comprises a coaxial electrosprayer.

3. The electric thruster of claim 1, wherein the upstream electrode electrically contacts a surface of the exterior channel to apply an electrical charge to the liquid flowing from the liquid source.

4. The electric thruster of claim 1, wherein the liquid is an electrically conductive low vapor pressure liquid.

5. The electric thruster or method of claim 4, wherein a vapor pressure of the liquid is between or equal to 10⁻¹⁵ and 0.1 mmHg.

6. The electric thruster of claim 4, wherein the liquid is an ionic liquid.

7. The electric thruster of claim 1, wherein the gas is substantially immiscible with the liquid.

8. The electric thruster of claim 1, wherein the bubbles have an average maximum transverse dimension between or equal to 10 nm and 150 μm.

9. The electric thruster of claim 1, wherein a ratio of an average shell thickness and the average maximum transverse dimension of the bubbles is between or equal to 0.5 and 10⁻⁴.

10. The electric thruster of claim 1, wherein an atomic mass of the gas is between or equal to 2 atomic mass units and 200 atomic mass units.

11. The electric thruster of claim 1, wherein the gas source is configured to pressurize the liquid source.

12. A method for generating thrust, the method comprising:
forming bubbles, wherein each bubble includes a shell comprising a liquid and a core comprising a gas;
electrically charging the bubbles; and
applying an accelerating potential to the electrically charged bubbles to generate thrust.

13. The method of claim 12, wherein forming bubbles comprises flowing a gas through a core channel and flowing a liquid through an exterior channel that at least partially surrounds the core channel.

14. The method of claim 12, wherein the liquid wets an exterior surface of a sprayer.

15. The method of claim 14, wherein the liquid passively wets the exterior surface of the sprayer.

16. An electric thruster comprising:
at least one sprayer, wherein each sprayer is configured to form bubbles including a shell comprising a liquid and a core comprising a gas;
a liquid source configured to contain the liquid and in fluid communication with the at least one sprayer;
a gas source configured to contain the gas and in fluid communication with the at least one sprayer;
an upstream electrode configured to apply a voltage potential to the liquid flowing from the liquid source to the at least one sprayer; and
an extractor electrode configured to accelerate the bubbles emitted from the at least one sprayer.

17. The electric thruster of claim 16, wherein the upstream electrode is in electrical contact with the at least one sprayer and configured to apply the voltage to the liquid.

18. The electric thruster of claim 17, wherein the at least one sprayer comprises:
an exterior surface, wherein the liquid source is configured to be in fluid communication with the exterior surface with the liquid disposed on the exterior surface; and
a gas channel in fluid communication with the exterior surface, the gas channel configured to flow the gas from the gas source to the exterior surface,
wherein the upstream electrode is configured to be in electrical contact with the exterior surface of the at least one sprayer to apply the voltage potential to the liquid disposed on the exterior surface.

19. The electric thruster of claim 18, wherein the exterior surface of the at least one sprayer at least partially surrounds the gas channel, and wherein when the liquid is disposed on the exterior surface, the liquid moves towards a distal opening of the at least one sprayer via capillary action.

20. The electric thruster of claim 18, wherein the exterior surface comprises an engineered surface configured to increase fluid affinity for the exterior surface.

21. The electric thruster of claim 18, wherein the exterior surface comprises a planar surface, wherein the gas channel extends through the planar surface and is configured to be in fluid communication with the liquid disposed on the exterior surface.

22. The electric thruster of claim 22, further comprising an array of openings extending through the exterior surface, wherein the array of openings comprises a plurality of gas openings extending through the exterior surface.

23. The electric thruster of claim 17, wherein the at least one sprayer comprises at least one coaxial sprayer, wherein each coaxial sprayer of the at least one coaxial sprayer includes a core channel and an exterior channel at least partially surrounding the core channel, wherein the liquid source is configured to be in fluid communication with the exterior channel, wherein the gas source is configured to be in fluid communication with the core channel, and wherein the upstream electrode in configured to be in electrical contact with the at least one coaxial sprayer to apply the voltage potential to the liquid in the exterior channel.
